(19) United States
(12) Patent Application Publication
(10) Pub. No.: US 2024/0073838 A1
(43) Pub. Date: Feb. 29, 2024

(54) MEDIUM ACCESS RECOVERY METHOD AND WIRELESS STATION

(71) Applicant: GUANGDONG OPPO MOBILE TELECOMMUNICATIONS CORP., LTD., Dongguan (CN)

(72) Inventors: Liuming LU, Dongguan (CN); Lei HUANG, Singapore (SG)

(21) Appl. No.: 18/388,000

(22) Filed: Nov. 8, 2023

Related U.S. Application Data
(63) Continuation of application No. PCT/CN2021/102223, filed on Jun. 24, 2021.

(51) Int. Cl. H04W 56/00; H04W 74/08

(52) U.S. Cl. CPC H04W 56/0015; H04W 74/0808; H04W 74/085

(57) ABSTRACT

A medium access recovery method executed by a wireless mobile station (STA) is provided. When losing medium synchronization due to transmission by another mobile station affiliated with the same multi-link device (MLD), the mobile station starts a medium synchronization delay timer, such as MediumSyncDelay timer, at the end of the transmission by another mobile station. The method improves medium access recovery by at least determining whether to allow backoff in a delay time kept by the delay timer, whether to allow overlapping basic service set (OBSS) packet detection (PD) spatial reuse (SR), or whether to reset the delay timer with respect to a subsequent transmission event, or adjusting an energy detection (ED) threshold.

### CROSS-REFERENCE TO RELATED APPLICATION

This application is a continuation of International Application No. PCT/CN2021/102223 filed on Jun. 24, 2021, the entire contents of which are incorporated herein by reference in its entirety.

### BACKGROUND ART

The present disclosure relates to the field of communication systems, and more particularly, to a medium access recovery method and a wireless station.

Communication systems such as wireless communication systems are widely deployed to provide various types of communication content such as voice, video, packet data, messaging, broadcast, and so on. These communication systems may be multiple-access systems capable of supporting communication with multiple users by sharing available system resources (such as time, frequency, and power). A wireless network, for example, a wireless local area network (WLAN), such as a WI-FI (institute of electrical and electronics engineers (IEEE) 802.11) network may include an access point (AP) that may communicate with one or more wireless mobile stations (STAs) or devices. The WLAN enables a user to wirelessly access internet based on radio frequency technology in a home, an office, or a specific service area using a portable terminal such as a personal digital assistant (PDA), a laptop computer, a portable multimedia player (PMP), a smartphone, etc. The AP may be coupled to a network, such as the internet, and may enable a mobile device to communicate via the network (or communicate with other devices coupled to the AP). A wireless device may communicate with a network device bi-directionally. For example, in a WLAN, an STA may communicate with an associated AP via downlink and uplink. The downlink may refer to a communication link from the AP to the STA, and the uplink may refer to a communication link from the STA to the AP.

### Technical Problem

IEEE 802.11be WG has introduced a multi-link device (MLD) in a WLAN extreme high throughput (EHT) feature and defined a multi-link (ML) discovery procedure for an STA affiliated with a non-AP MLD to solicit ML capabilities of APs affiliated with an AP MLD. An MLD is an IEEE 802.11 capable device that is a logical entity and has two or more affiliated stations (STAs) and a single medium access control (MAC) service access point (SAP) to logical link control (LLC), which includes one MAC data service.

IEEE 802.11be draft 1.0 has specified a medium access recovery procedure to address the blindness issue at a non-AP multi-link device (MLD) of non-simultaneous transmit and receive (NSTR). Current specification of the medium access recovery procedure, however, has the following problems:
During a period of time kept by a medium synchronization delay timer, such as the MediumSyncDelay (MSD) timer in the standard, the energy detection (ED) threshold in a range of [−72, −62] dBm could be lower than the spatial reuse (SR) overlapping basic service set (OBSS) packet detection (PD) level, which may cause unexpected exceptions for the OBSS PD SR.
The current requirements of STA during a nonzero MediumSyncDelay timer only apply to the case that an STA attempts to obtain a transmission opportunity (TXOP). No sufficient rules for network management are available in the current standards.
No sufficient rules or limitations are available to allow efficient operations associated with the MediumSyncDelay timer, referred to as a MediumSyncDelay time or an MSD time. For example, an NSTR STA cannot efficiently utilize the wireless channels when the NSTR STA fails to detect a valid physical layer (PHY) protocol data unit (PPDU) during the MSD time and clear channel assessment (CCA) shows channel busy. An NSTR STA refers to a STA belonging to a NSTR link pair.

Hence, it is desirable to provide a medium access recovery method and a wireless device to address the problems in the current standards.

### Technical Solution

An object of the present disclosure is to propose a medium access recovery method and a wireless station.

A first aspect of the disclosure provides a medium access recovery method comprising:
starting a medium synchronization delay timer of a wireless station to time a medium synchronization delay period when the wireless station affiliated with a non-access point multi-link device (non-AP MLD) that belongs to a wireless link pair has lost medium synchronization due to a first transmission event, wherein the medium synchronization delay timer times the medium synchronization delay period;
detecting the wireless link pair for at least one of the first transmission event or a second transmission event on at least a link of the wireless link pair, wherein the second transmission event occurs after the first transmission event; and determining whether to adjust the medium synchronization delay period based on the detecting of the wireless link pair for the at least one of the first transmission event or the second transmission event.

A second aspect of the disclosure provides a medium access recovery method comprising:
starting a medium synchronization delay timer of a wireless station to time a medium synchronization delay period when the wireless station affiliated with a non-access point multi-link device (non-AP MLD) that belongs to a wireless link pair has lost medium synchronization, wherein the medium synchronization delay timer times the medium synchronization delay period; and
using an adjusted energy detection (ED) threshold for clear channel assessment (CCA) during the medium synchronization delay period.

A third aspect of the disclosure provides a wireless station comprising a processor and a transceiver. The processor is connected to the transceiver and configured to execute the following steps:
starting a medium synchronization delay timer of a wireless station to time a medium synchronization delay period when the wireless station affiliated with a non-access point multi-link device (non-AP MLD) that belongs to a wireless link pair has lost medium synchronization due to a first transmission event, wherein the medium synchronization delay timer times the medium synchronization delay period;
detecting the wireless link pair for at least one of the first transmission event or a second transmission event on at least a link of the wireless link pair, wherein the second transmission event occurs after the first transmission event; and
determining whether to adjust the medium synchronization delay period based on the detecting of the wireless link pair for the at least one of the first transmission event or the second transmission event.

A fourth aspect of the disclosure provides a wireless station comprising a processor and a transceiver. The processor is connected to the transceiver and configured to execute the following steps:
starting a medium synchronization delay timer of a wireless station to time a medium synchronization delay period when the wireless station affiliated with a non-access point multi-link device (non-AP MLD) that belongs to a wireless link pair has lost medium synchronization, wherein the medium synchronization delay timer times the medium synchronization delay period; and
using an adjusted energy detection (ED) threshold for clear channel assessment (CCA) during the medium synchronization delay period.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as computer program product, that causes a computer to execute the disclosed method.

The disclosed method may be programmed as computer program, that causes a computer to execute the disclosed method.

### Advantageous Effects

Embodiments of the disclosure provides a medium access recovery method executed by a wireless mobile station (STA). When losing medium synchronization due to transmission by another mobile station affiliated with the same multi-link device (MLD), the mobile station starts a medium synchronization delay timer, such as MediumSyncDelay timer, at the end of the transmission by another mobile station. The method improves medium access recovery by at least determining whether to allow backoff in a delay time kept by the delay timer, whether to allow overlapping basic service set (OBSS) packet detection (PD) spatial reuse (SR), or whether to reset the delay timer with respect to a subsequent transmission event, or adjusting an energy detection (ED) threshold.

### DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating a case with inadequate protection during a period of a MediumSyncDelay timer.

FIG. 2 is a schematic diagram illustrating an example of a wireless communications system according to an embodiment of the present disclosure.

FIG. 3 is a schematic diagram illustrating one or more stations (STAs) and an access point (AP) of communication in a wireless communications system according to an embodiment of the present disclosure.

FIG. 4 is a schematic diagram showing a medium access recovery method according to an embodiment of the disclosure.

FIG. 5 is a schematic diagram showing a medium access recovery method that disallows backoff according to a first embodiment of the disclosure.

FIG. 6 is a schematic diagram showing a medium access recovery method using an adjusted energy detection threshold according to a second embodiment of the disclosure.

FIG. 7 is a schematic diagram showing a medium access recovery method that disallows spatial reuse according to a third embodiment of the disclosure.

FIG. 8 is a schematic diagram showing a medium access recovery method that reset a timer using duration information according to a fourth embodiment of the disclosure.

FIG. 9 is a schematic diagram showing a medium access recovery method according to a fifth embodiment of the disclosure.

FIG. 10 is a schematic diagram showing a medium access recovery method according to a sixth embodiment of the disclosure.

FIG. 11 is a schematic diagram showing a medium access recovery method according to a seventh embodiment of the disclosure.

FIG. 12 is a schematic diagram showing a medium access recovery method according to an eighth embodiment of the disclosure.

FIG. 13 is a schematic diagram showing a medium access recovery method according to a ninth embodiment of the disclosure.

FIG. 14 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

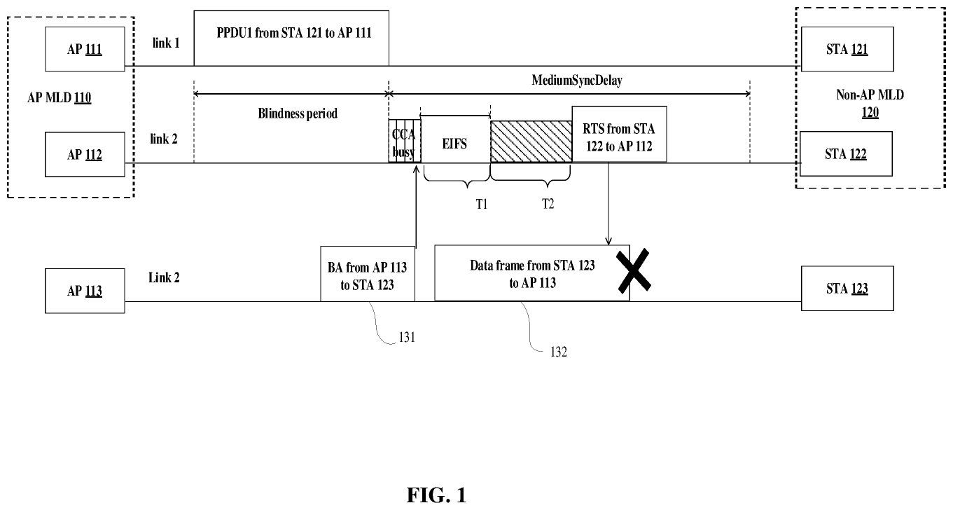

With reference to FIG. 1, a non-AP MLD 120 comprises an STA 121 belonging to a NSTR link pair and an STA 122 belonging to the same NSTR link pair. An NSTR STA refers to a STA belonging to a NSTR link pair. The NSTR STA 121 and the NSTR STA 122 are affiliated with the same non-AP MLD 120. An AP MLD 110 comprises an AP 111 and an AP STA 112. The AP 111 and the AP 112 are affiliated with the same AP MLD 110. When failing to detect a valid PPDU, such as a block acknowledgement (BA) frame 131 from an AP 113 to a STA 123, the NSTA STA 122 defers for an extended interframe space (EIFS) T1 and performs a backoff during a backoff period T2. In this case, the STA 123 is hidden or undetectable to the STA 122 affiliated with the NSTR MLD 120 on a link 2. In some conditions, the STA 123 may transmit a PPDU 132 in a transmission opportunity (TxOP), where the PPDU 132 is much longer than BA frame 131. Since the STA 123 is hidden to the STA 122 affiliated with the NSTR MLD 120 on the link 2, the NSTR MLD 120 cannot detect the PPDU 132 sent from the STA 123. In such case, the EIFS T1 cannot provide enough protection since the EIFS T1 can be as short as aSIFSTime+AckTxTime+DIFS=94 us, for ACK in 6 Mbps.

In implicitly resetting a MediumSyncDelay timer, a valid duration of a medium access control (MAC) protocol data unit (MPDU) transmission can be obtained to update a network allocation vector (NAV). Resetting of the MSD timer for a valid medium access control MPDU without duration information, such as a power saving poll (PS-Poll), cannot provide enough protection for other potential transmission of the same or different STAs. Additionally, the transmissions of quality of service (QoS) data frames and management frames adopt different channel access methods, i.e., the enhanced distributed channel access (EDCA) mechanism is used to obtain a TXOP to transmit QoS data frames and distributed coordination function (DCF) is used to access channel to transmit management frames.

IEEE 802.11be Draft 1.0 has specified the medium access recovery procedure. According to the medium access recovery procedure, a first STA, such as the STA 122, and a second STA, such as the STA 121, are affiliated with a non-AP MLD, such as the non-AP MLD 120, that belong to a NSTR link pair. The first STA is considered to have lost medium synchronization due to uplink (UL) interference when the second STA, which is affiliated with the same non-AP MLD and belongs to the NSTR link pair, transmits a PPDU, except when both STAs ended a transmission at the same time.

The first STA that has lost medium synchronization due to a transmission event initiated by the second STA affiliated with the same MLD starts a MediumSyncDelay timer at the end of the transmission event if the transmission event is longer than aMediumSyncThreshold. The aMediumSyncThreshold is a pre-configured parameter for medium synchronization threshold in the standards. The first STA may not start the MediumSyncDelay timer if the transmission event is shorter than or equal to aMediumSyncThreshold.

The MediumSyncDelay timer is a single timer, shared by all enhanced distributed channel access functions (EDCAFs) within a non-AP STA, which is initialized to aPPDUMaxTime defined in Table 36-69 in the standards, for extremely high throughput (EHT) physical layer (PHY) characteristics. The STA shall update its MediumSyncDelay timer to the one contained in a medium synchronization field, if present, of the basic variant multi-Link element in the most recent frame received from an associated AP MLD, such as AP MLD 110. The timer resets to zero when any of the following events occur:
The first STA receives a PPDU with a valid MPDU; or
The first STA receives a PPDU of which a corresponding RXVECTOR parameter TXOP_DURATION is not UNSPECIFIED.

The first STA affiliated with the non-AP MLD that has a nonzero MediumSyncDelay timer that supports to obtain a TXOP may perform:
transmitting a request to send (RTS) frame as a first frame of any attempt to obtain a TXOP;
attempting to initiate more than MSD_TXOP_MAX TXOPs; and/or
using a CCA_ED threshold that is equal to dot11MSDOFDMEDthreshold.

In the standards during the aCCAtime (see 36.3.20.6.3 (CCA sensitivity for occupying the primary 20 MHz channel)) immediately following the end of the transmission event that caused loss of medium synchronization and subsequent initiation of the MediumSyncDelay timer at the non-AP STA, if the received signal strength exceeds the CCA-ED threshold as given by dot11OFDMEDThreshold for the primary 20 MHz channel and no start of a PPDU is detected, the non-AP STA should defer for EIFS beginning when the received signal strength falls below the CCA-ED threshold.

The application provides embodiments of the disclosure to address the problems in the current specification of medium access recovery procedure in IEEE 802.11be Draft 1.0.

The following description is directed to certain embodiments for the purposes of describing the innovative aspects of the present disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the IEEE 802.11 standards, the Bluetooth® standard, code division multiple access (CDMA), frequency division multiple access (FDMA), time division multiple access (TDMA), global system for mobile communications (GSM), GSM/general packet radio service (GPRS), enhanced data GSM environment (EDGE), terrestrial trunked radio (TETRA), wideband-CDMA (W-CDMA), evolution data optimized (EV-DO), 1×EV-DO, EV-DO Rev A, EV-DO Rev B, high speed packet access (HSPA), high speed downlink packet access (HSDPA), high speed uplink packet access (HSUPA), evolved high speed packet access (HSPA+), long term evolution (LTE), AMPS, or other known signals that are used to communicate within a wireless, cellular or internet of things (JOT) network, such as a system utilizing 3G, 4G, or 5G, or further implementations thereof, technology. Standards in the description may at least refer to one or more versions of the IEEE 802.11 specifications.

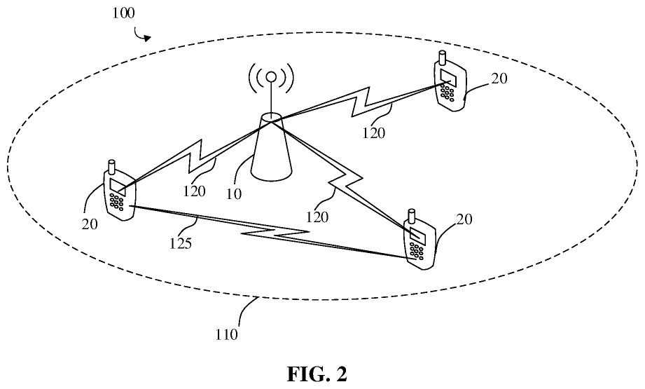

FIG. 2 illustrates an example of a wireless communications system according to an embodiment of the present disclosure. The wireless communications system may be an example of a wireless local area network (WLAN) 100 configured in accordance with various aspects of the present disclosure. The WLAN is also known as a WI-FI network, such as next generation, next big thing (NBT), ultra-high throughput (UHT) or EHT Wi-Fi network. As described herein, the terms next generation, NBT, UHT, and EHT may be considered synonymous and may each correspond to a Wi-Fi network supporting a high volume of space-time-streams. The WLAN 100 may include an AP 10 and multiple associated STAs 20, which may represent devices such as mobile stations, personal digital assistant (PDAs), other handheld devices, netbooks, notebook computers, tablet computers, laptops, display devices (such as TVs, computer monitors, etc.), printers, etc. The AP 10 and the associated stations 20 may represent a basic service set (BSS) or an extended service set (ESS). The various STAs 20 in the network can communicate with one another through the AP 10. Also illustrated is a coverage area 110 of the AP 10, which may represent a basic service area (BSA) of the WLAN 100. An extended network station (not shown) associated with the WLAN 100 may be connected to a wired or wireless distribution system that may allow multiple APs 10 to be connected in an ESS.

In some embodiments, an STA 20 may be located in the intersection of more than one coverage area 110 and may associate with more than one AP 10. A single AP 10 and an associated set of STAs 20 may be referred to as a BSS. An ESS is a set of connected BSSs. A distribution system (not shown) may be used to connect APs 10 in an ESS. In some cases, the coverage area 110 of an AP 10 may be divided into sectors (also not shown). The WLAN 100 may include APs 10 of different types (such as a metropolitan area, home network, etc.), with varying and overlapping coverage areas 110. Two STAs 20 also may communicate directly via a direct wireless link 125 regardless of whether both STAs 20 are in the same coverage area 110. Examples of direct wireless links 126 may include Wi-Fi direct connections, Wi-Fi tunneled direct link setup (TDLS) links, and other group connections. STAs 20 and APs 10 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.11ay, etc. In some other implementations, peer-to-peer connections or ad hoc networks may be implemented within the WLAN 100.

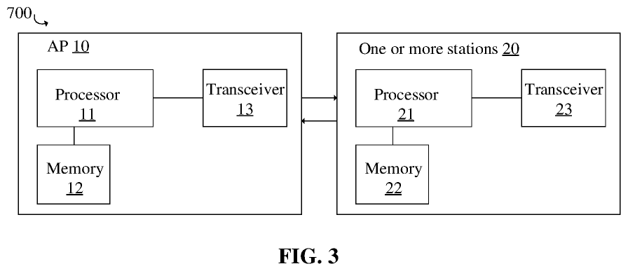

FIG. 3 illustrates one or more stations (STAs) 20 and an access point (AP) 10 of communication in a wireless communications system 700 according to an embodiment of the present disclosure. FIG. 3 illustrates that, the wireless communications system 700 includes an access point (AP) 10 and one or more stations (STAs) 20. The AP 10 may include a memory 12, a transceiver 13, and a processor 11 coupled to the memory 12, the transceiver 13. The one or more STAs 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 21 is configured to perform the disclosed method in the embodiments of the disclosure. The STAs 121, 122, and 123 are examples of a STA 20. The AP 111, 112, and 113 are examples of the AP 10.

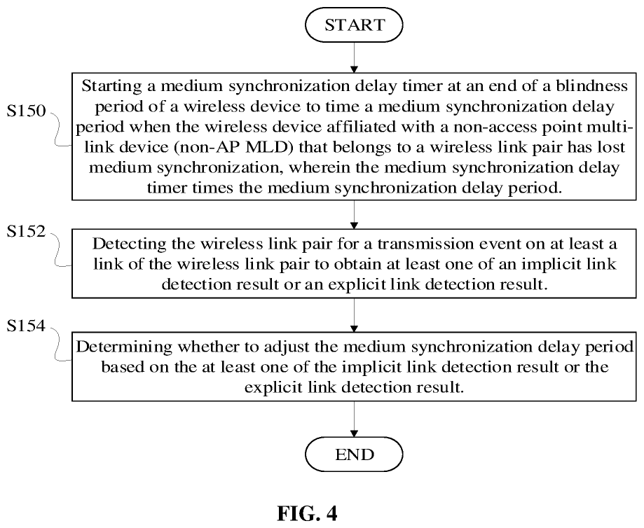

With reference to FIG. 4, a wireless device, such as the first STA or the STA 122, starts a medium synchronization delay timer at an end of a blindness period of the wireless device to time a medium synchronization delay period when the wireless device affiliated with a non-access point multi-link device (non-AP MLD) that belongs to a wireless link pair has lost medium synchronization, wherein the medium synchronization delay timer times the medium synchronization delay period (step S150). The medium synchronization delay timer may comprise the MediumSyncDelay timer, and the medium synchronization delay period may comprise the MediumSyncDelay period timed by the MediumSyncDelay timer.

The wireless device detects the wireless link pair for a transmission event on at least a link of the wireless link pair to obtain at least one of an implicit link detection result or an explicit link detection result (step S152). The implicit link detection result may comprise a probability of a wireless transmission on a WLAN channel. The explicit link detection result may comprise duration information in a duration/ID field, a beginning, an end, or duration of a second transmission event subsequent to transmission event.

The wireless device determines whether to adjust the medium synchronization delay period based on the at least one of the implicit link detection result or the explicit link detection result (step S154). The wireless device may adjust the medium synchronization delay period by starting, resetting, or restarting the medium synchronization delay timer. The wireless device may determine a first corresponding rule to adjust the medium synchronization delay period according to the implicit link detection result, determine a second corresponding rule to adjust the medium synchronization delay period according to the explicit link detection result, and apply the first corresponding rule and the second corresponding rule accordingly.

The first STA, such as the STA 122, that has lost medium synchronization due to a transmission event performed by a second STA, such as the STA 121, affiliated with the same MLD, such as the non-AP MLD 120, starts the MediumSyncDelay timer at the end of the transmission event if the transmission event is longer than the aMediumSyncThreshold. The first STA may use one or several or all of the following solutions or rules in the embodiments during the period of the MediumSyncDelay timer when the MediumSyncDelay is not equal to 0.

In an embodiment, if the first STA fails to detect a beginning of a PPDU during a CCA operation that indicates a link is busy, the following two cases may occur:
Case 1: if the first STA detects an IEEE 802.11 transmission having a probability of being at or above a specified signal strength threshold at a specified bandwidth within a period, such as aCCAMidTime or aCCAMidTime2, the first STA, i.e., an NSTR STA, may disallow backoff of the first STA in the MediumSyncDelay time. The probability may be a probability higher than a probability threshold, such as 90%. For example, the probability may be more than 90%.
Case 2: if case 1 doesn't happen, the first STA, i.e., an NSTR STA, may defer the EIFS time.

The period aCCAMidTime2 represents the maximum time (in microseconds) available for the CCA mechanism to detect an IEEE 802.11 transmission. The value of aCCAMidTime2 can be equal to aCCAMidTime in current specification. The aCCAMidTime is a constant defined in the standards, such as IEEE 802.11-2020, representing a maximum time for CCA to determine whether an IEEE 802.11 transmission is on a non-primary channel. For example, the specified signal strength threshold may comprise the PD level in the standards. In an embodiment, the implicit link detection result shows that the wireless device detects a contention-based wireless transmission having a high probability of being at or above a specified signal strength threshold, such as the PD level, at a specified bandwidth within a period, such as the aCCAMidTime or the aCCAMidTime2. The first STA disallows backoff during the medium synchronization delay period in response to the implicit link detection result. The first STA defers a beginning of an extended interframe space (EIFS) and allows backoff during the medium synchronization delay period when the wireless device does not detect the implicit link detection result.

In an embodiment, the following option 1 or option 2 shall be adopted to avoid unexpected cases for the OBSS PD SR.
Option 1: The first STA adjusts the ED threshold. The adjusted ED threshold is not lower than a Spatial Reuse OBSS PD level.
Option 2: The first STA disallows the OBSS PD SR.

In an embodiment, the explicit link detection result may comprise duration information in a duration/ID field. The first STA resets the MediumSyncDelay timer to zero when receiving a PPDU with a valid MPDU with a Duration/ID field carrying duration information, and does not reset the MediumSyncDelay timer to zero when receiving a PPDU with a valid MPDU with a Duration/ID field carrying no duration information. The ID in the Duration/ID field means identifier.

In an embodiment, the first STA makes the rule of using adjusted ED threshold as a common rule during the MSD time kept by the MediumSyncDelay timer. For example, the first STA affiliated with the non-AP MLD 120 that has a nonzero MediumSyncDelay timer may use the CCA-energy detect threshold (CCA_ED threshold) that is equal to dot11MSDOFDMEDthreshold as defined in the standards. The Medium Synchronization OFDM ED Threshold subfield indicates the value of dot11MSDOFDMED-threshold threshold to be used by a non-AP STA during medium synchronization recovery.

In an embodiment, the explicit link detection result may comprise a beginning or an end of a second transmission event after transmission event. After the first STA affiliated with the non-AP MLD 120 started a MediumSyncDelay timer after losing medium synchronization, if the first STA loses medium synchronization again due to a second transmission performed by the second STA affiliated with the same MLD during the MSD time kept by the MediumSyncDelay timer, the first STA may perform one or more or all of the following solutions and rules:

In an embodiment, the first STA doesn't reset the MSD timer to 0 when the second transmission event starts and restarts the MediumSyncDelay timer at the end of the second transmission if the second transmission event is also longer than aMediumSyncThreshold.

In an embodiment, the first STA resets the MediumSyncDelay timer to 0 when the second transmission event starts and restarts the MediumSyncDelay timer at the end of the second transmission if the second transmission event is also longer than aMediumSyncThreshold.

In an embodiment, the first STA resets the MediumSyncDelay timer to 0 when the second transmission event starts and doesn't restart the MediumSyncDelay timer at the end of the second transmission if the second transmission event is not longer than aMediumSyncThreshold.

In an embodiment, the first STA doesn't reset the MediumSyncDelay timer to 0 when the second transmission event starts and doesn't restart the MediumSyncDelay timer at the end of the second transmission if the second transmission event is not longer than aMediumSyncThreshold.

In an embodiment, the first STA doesn't reset the MSD timer to 0 when the second transmission event starts if detecting the second transmission event being not longer than aMediumSyncThreshold.

In an embodiment, the first STA resets the MediumSyncDelay timer to 0 when the second transmission event starts if detecting that the second transmission event is longer than aMediumSyncThreshold, and restarts the MediumSyncDelay timer at the end of the second transmission.

In an embodiment, the first STA affiliated with the non-AP MLD 120 that belongs to an NSTR link pair obtains a TXOP and operates as a TXOP holder. The first STA transmits an AP assistance request (AAR) control subfield in a frame that is the last frame transmitted by the first STA in a TXOP to an associated first AP, such as the AP 112, affiliated with an AP MLD, such as the AP MLD 110, which indicates a link identifier of a second AP, such as the AP 111, affiliated with the same AP MLD to solicit the second AP to transmit a trigger frame to the second STA affiliated with the same non-AP MLD that belongs to the same NSTR link pair. The first STA transmits a PPDU with the frame carrying the AAR control subfield in the TXOP to the first AP affiliated with the AP MLD. The transmission of the PPDU with the frame carrying the AAR control subfield solicits the second AP affiliated with the same AP MLD to transmit the trigger frame after the end of the last PPDU transmitted by the first STA in the TXOP.

### Embodiment 1

For the NSTR MLD 120, the first STA, i.e., the STA 122, affiliated with a non-AP MLD that belongs to an NSTR link pair has lost medium synchronization due to a transmission event performed by the second STA, such as the STA 121, in the link pair affiliated with the same non-AP MLD. The STA 122 starts a MediumSyncDelay timer at the end of the transmission event if the transmission event is longer than aMediumSyncThreshold. During the period of the MediumSyncDelay timer when the MediumSyncDelay is not equal to 0, if the first STA fails to detect a start of PPDU and CCA is busy, the first STA may operate according to the following two cases:

Case 1: If the first STA detects an IEEE 802.11 transmission having a probability of being at or above a specified signal strength threshold at a specified bandwidth within a period, such as aCCAMidTime or aCCAMidTime2, the first STA, i.e., an STA, may disallow backoff during the period of the MediumSyncDelay timer when the MediumSyncDelay is not equal to 0. The probability may be a probability higher than a probability threshold, such as 90%. For example, the probability may be more than 90%. For example, if the first STA detects a non-high-throughput (non-HT), high throughput mixed format (HT_MF), high throughput greenfield (HT_GF), very high throughput (VHT), high efficiency (HE), or extremely high throughput (EHT) PPDU for which the power measured within a 20 MHz subchannel has >90% probability of being at or above max(−72 dBm, OBSS_PDlevel) with within a period, such as aCCAMidTime or aCCAMidTime2, the STA disallows backoff in the MediumSyncDelay time (i.e. the period of the MediumSyncDelay timer when the MediumSyncDelay is not equal to 0).

Case 2: if the received signal strength exceeds the CCA-ED threshold as given by dot11OFDMEDThreshold for the primary 20 MHz channel and no PPDU for the 802.11 transmission is detected, the first STA defers for EIFS beginning when the received signal strength falls below the CCA-ED threshold, and allows backoff in the MediumSyncDelay time.

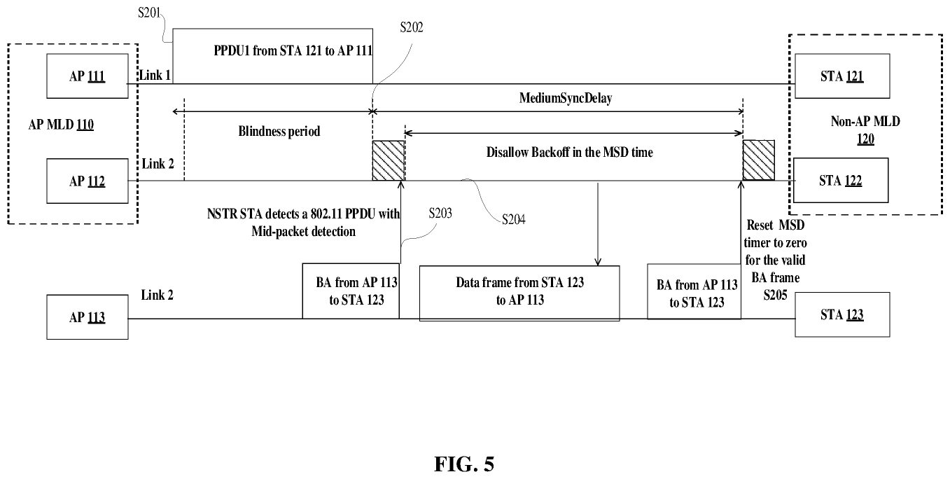

With reference to FIG. 5, the NSTR non-AP MLD 120 which has two affiliated STAs, i.e., the STA 121 and the STA 122, is associated with the AP MLD 110 which has two affiliated APs (i.e., AP 111 and the AP 112). The link 1 between the AP 111 and the non-AP STA 121 and the link 2 between the AP 112 and the non-AP STA 122 have been set up between the non-AP MLD 120 and AP MLD 110. The non-AP MLD 120 has one NSTR pair of links including link 1 and link 2. A single STA (i.e., the STA 123) is associated with another AP (i.e., AP 113) operating on link 2. The STA 123 is a hidden station for the STA 122, which means that the STA 122 cannot detect PPDUs transmitted by the STA 123 to AP 113. The STA 121 transmits a PPDU (i.e., the PPDU1) to the AP 111, which causes the STA 122 to lose the medium synchronization for a blindness period (step S201). At the end of the transmission of the PPDU1, the STA 122 starts the MediumSyncDelay timer (step S202). At the beginning of the period of the MediumSyncDelay timer (i.e., MSD time), the STA 122 detects an IEEE 802.11 PPDU with mid-packet detection (step S203), and the detected PPDU with a BA is transmitted by the AP 113 to the STA 123 on link 2. The STA 122 disallows backoff (step S204) during the period of the MediumSyncDelay timer when the MediumSyncDelay timer is not equal to 0, which can provide further protection for other potential transmissions on the NSTR pair of links. The STA 122 resets the MediumSyncDelay timer to zero when the STA 122 receives a PPDU with a valid BA frame from AP 113 to the STA 123 (step S205). The embodiment provides a solution for providing more reasonable protection during MediumSyncDelay time.

### Embodiment 2

For the NSTR MLD 120, the first STA, i.e., the NSTR STA 122, affiliated with the MLD that belongs to the NSTR link pair has lost medium synchronization due to the transmission event performed by the second STA, such as the STA 121, in the link pair affiliated with the same MLD. The STA 122 starts a MediumSyncDelay timer at the end of the transmission event if the transmission event is longer than aMediumSyncThreshold. During the period of the MediumSyncDelay timer when the MediumSyncDelay is not equal to 0, each of the STA 121 and the STA 122 uses an adjusted ED threshold for clear channel assessment (CCA), where the adjusted ED threshold is not lower than the Spatial Reuse OBSS PD level.

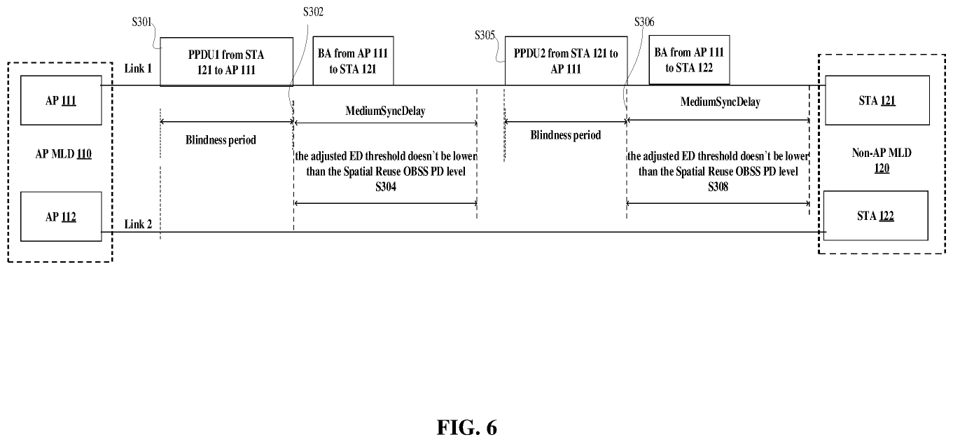

With reference to FIG. 6, the NSTR non-AP MLD 120 which has two affiliated STAs (i.e., the STA 121 and the STA 122), is associated with the AP MLD 110 which has two affiliated APs (i.e., the AP 111 and the AP 112). The link 1 between the AP 111 and non-AP STA 121 and the link 2 between the AP 112 and non-AP STA 122 have been set up between the non-AP MLD 120 and AP MLD 110. The non-AP MLD 120 has one NSTR pair of links including the link 1 and the link 2. The STA 121 transmits a PPDU, such as the PPDU1 or the PPDU2, to the AP 111, which causes the STA 122 to lose the medium synchronization for a blindness period (steps S301 and S305). At the end of the transmission of the PPDU1 or the PPDU2, the STA 122 starts the MediumSyncDelay timer (steps S302 and S306). During the period of the MediumSyncDelay timer when the MediumSyncDelay is not equal to 0, the STA 121 uses an adjusted ED threshold for clear channel assessment (steps S304 and S308). The adjusted ED threshold is maintained to be not lower than the Spatial Reuse OBSS PD level, which would avoid the happening of unexpected cases. The embodiment provides a solution to the issue for the adjusted ED threshold.

### Embodiment 3

For the NSTR MLD 120, the first STA, i.e., the NSTR STA 122, affiliated with the MLD 120 that belongs to the NSTR link pair has lost medium synchronization due to the transmission event performed by the second STA, such as the STA 121, in the link pair affiliated with the same MLD. The STA 122 starts a MediumSyncDelay timer at the end of the transmission event if the transmission event is longer than aMediumSyncThreshold. During the period of the MediumSyncDelay timer when the MediumSyncDelay is not equal to 0 the OBSS PD SR is disallowed.

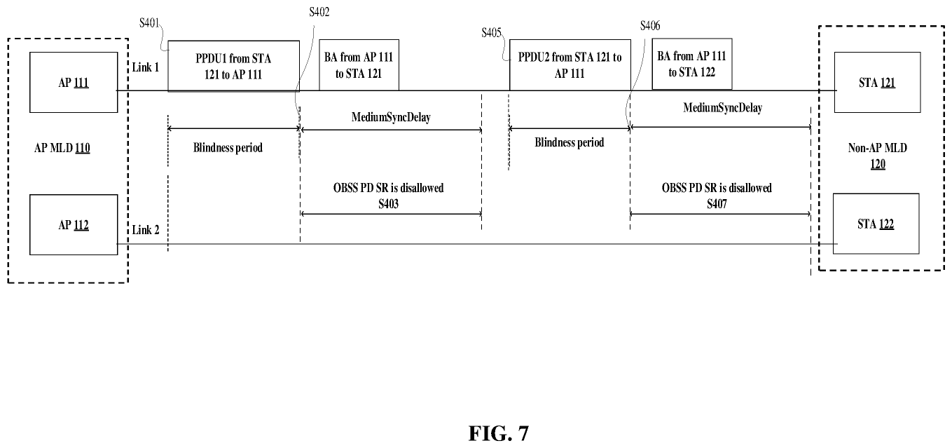

With reference to FIG. 7, the NSTR non-AP MLD 120 which has two affiliated STAs (i.e., the STA 121 and the STA 122), is associated with the AP MLD 110 which has two affiliated APs (i.e., the AP 111 and the AP 112). An NSTR non-AP MLD is a non-AP MLD belongs to a NSTR link pair. The link 1 between the AP 111 and non-AP STA 121 and the link 2 between the AP 112 and non-AP STA 122 have been set up between the non-AP MLD 120 and AP MLD 110. The non-AP MLD 120 has one NSTR pair of links including the link 1 and the link 2. The STA 121 transmits a PPDU, such as a PPDU1 or a PPDU2, to the AP 111, which causes the STA 122 to lose the medium synchronization for a blindness period (steps S401 and S405). At the end of the transmission of the PPDU1 or the PPDU2, the STA 122 starts the MediumSyncDelay timer (steps S402 and S406). During the period of the MediumSyncDelay timer when the MediumSyncDelay is not equal to 0 the OBSS PD SR is disallowed (steps S403 and S407), which would avoid the happening of unexpected cases. The embodiment provides a solution to the issue for the adjusted ED threshold.

### Embodiment 4

For the NSTR MLD 120, the first STA, i.e., the STA 122, affiliated with the MLD that belongs to the NSTR link pair has lost medium synchronization due to the transmission event performed by the second STA, such as the STA 121, in the link pair affiliated with the same MLD. The STA 122 starts a MediumSyncDelay timer at the end of the transmission event if the transmission event is longer than aMediumSyncThreshold. The STA 122 resets the MediumSyncDelay timer to zero when the first STA receives a PPDU with a valid MPDU which has a Duration/ID field carrying duration information. The STA 122 does not reset the MediumSyncDelay timer to zero when the first STA receives a PPDU with a valid MPDU which has a Duration/ID field carrying no duration information.

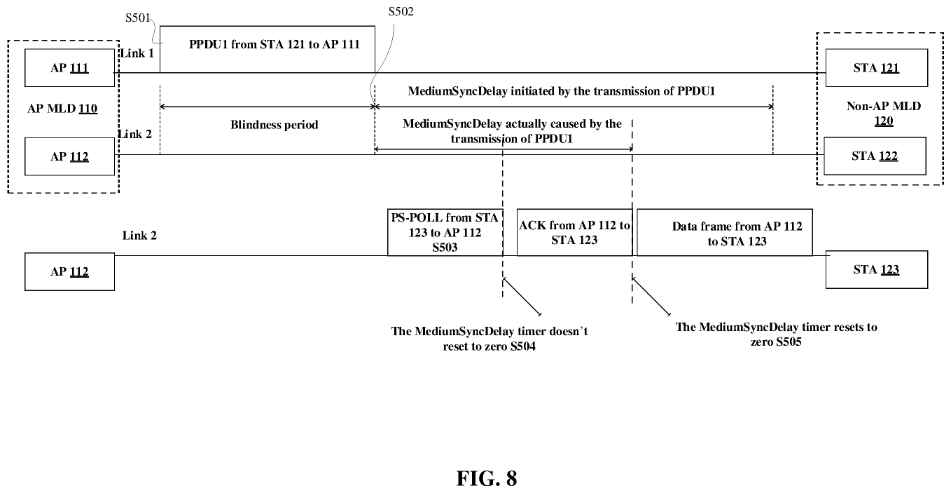

With reference to FIG. 8, the NSTR non-AP MLD 120 which has two affiliated STAs (i.e., the STA 121 and the STA 122), is associated with the AP MLD 110 which has two affiliated APs (i.e., the AP 111 and the AP 112). The link 1 between the AP 111 and the non-AP STA 121 and the link 2 between the AP 112 and the non-AP STA 122 have been set up between the non-AP MLD 120 and AP MLD 110. The non-AP MLD 120 has one NSTR pair of links including the link 1 and the link 2. A single STA, such as the STA 123, is associated with the AP 112 operating on the link 2, and the STA 122 can detect PPDUs transmitted between the STA 123 and the AP 112. The STA 121 transmits a PPDU, such as the PPDU1, to the AP 111, which causes the STA 122 to lose the medium synchronization for a blindness period (step S501). At the end of the transmission of the PPDU1, the STA 122 starts the MediumSyncDelay timer (step S502). During the period of the MediumSyncDelay timer when the MediumSyncDelay is not equal to 0, the STA 122 firstly detects a PS-POLL frame transmitted from the STA 123 to the AP 112 (step S503), the STA doesn't reset the MediumSyncDelay timer to zero when the PS-POLL frame which has Duration/ID field carrying no duration information (step S504). When detecting an ACK frame transmitted from the AP 112 to the STA 123 where the ACK frame which has Duration/ID field carrying duration information, the STA 122 resets the MediumSyncDelay timer to zero according to a duration in the Duration/ID field (step S505). The MediumSyncDelay timer initiated by the transmission of the PPDU1 keeps a value exactly the same as a value of the MediumSyncDelay timer initiated when the STA 122 starts the MediumSyncDelay timer. The MediumSyncDelay has a value actually caused by the transmission of the PPDU1, which represents a time period from the time that the first STA starts the MediumSyncDelay timer to the time that the MediumSyncDelay timer countdowns to zero or is reset to zero. The embodiment provides a solution to address the issue for the valid MPDU.

### Embodiment 5

After the first STA, such as the STA 122, affiliated with the non-AP MLD 120 that belongs to the NSTR link pair started a MediumSyncDelay timer due to having lost medium synchronization, if the first STA lost medium synchronization again due to the second transmission event performed by the second STA, such as the STA 121, in the link pair affiliated with the same MLD during the MediumSyncDelay timer is running, the first STA doesn't reset the MSD timer to 0 when the second transmission event starts and restarts the MediumSyncDelay timer at the end of the second transmission if the second transmission event is longer than aMediumSyncThreshold.

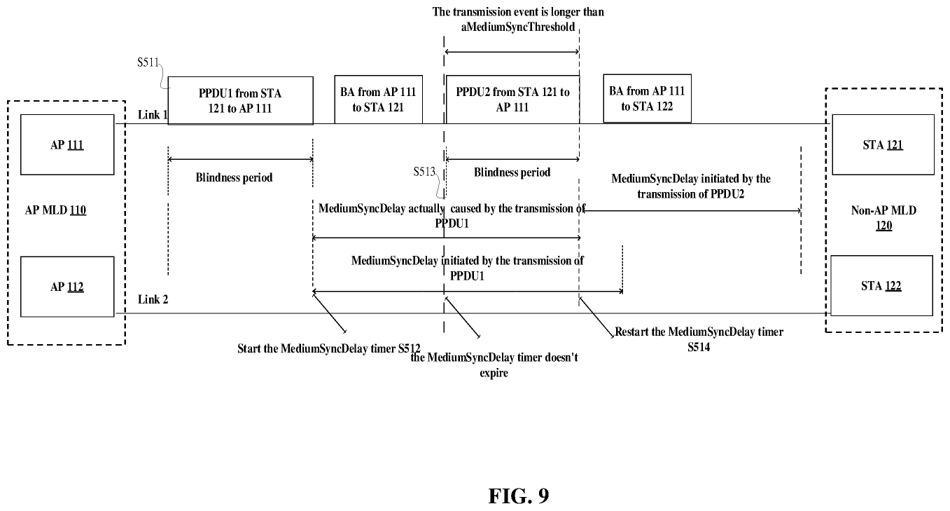

With reference to FIG. 9, the NSTR non-AP MLD 120 which has two affiliated STAs (i.e., the STA 121 and the STA 122), is associated with the AP MLD 110 which has two affiliated APs (i.e., the AP 111 and the AP 112). The link 1 between the AP 111 and the non-AP STA 121 and the link 2 between the AP 112 and the non-AP the STA 122 have been set up between the non-AP MLD 120 and AP MLD 110. The non-AP MLD 120 has one NSTR pair of links including the link 1 and the link 2. The STA 121 transmits a PPDU, such as a PPDU1, to the AP 111, which causes the STA 122 to lose the medium synchronization for a blindness period (step S511). At the end of the transmission of the PPDU1, the STA 122 starts the MediumSyncDelay timer (step S512). During the period of the MediumSyncDelay timer when the MediumSyncDelay is not equal to 0, the STA 122 doesn't reset the MSD timer to 0 when the transmission of the PPDU2 starts (step S513) and restarts (step S514) the MediumSyncDelay timer at the end of the transmission of the PPDU2 if the transmission event of the PPDU2 is also longer than aMediumSyncThreshold. The embodiment provides a solution to address the issue for the sequential blindness periods.

### Embodiment 6

After the first STA, such as the STA 122, affiliated with the non-AP MLD 120 that belongs to the NSTR link pair started a MediumSyncDelay timer due to having lost medium synchronization, if the first STA lost medium synchronization again due to the second transmission event performed by the second STA, such as the STA 121, in the link pair affiliated with the same MLD during the MediumSyncDelay timer is running, the first STA when detecting that the second transmission event is also longer than the aMediumSyncThreshold and resets the MediumSyncDelay timer to 0 when the second transmission event starts and restarts the MediumSyncDelay timer at the end of the second transmission.

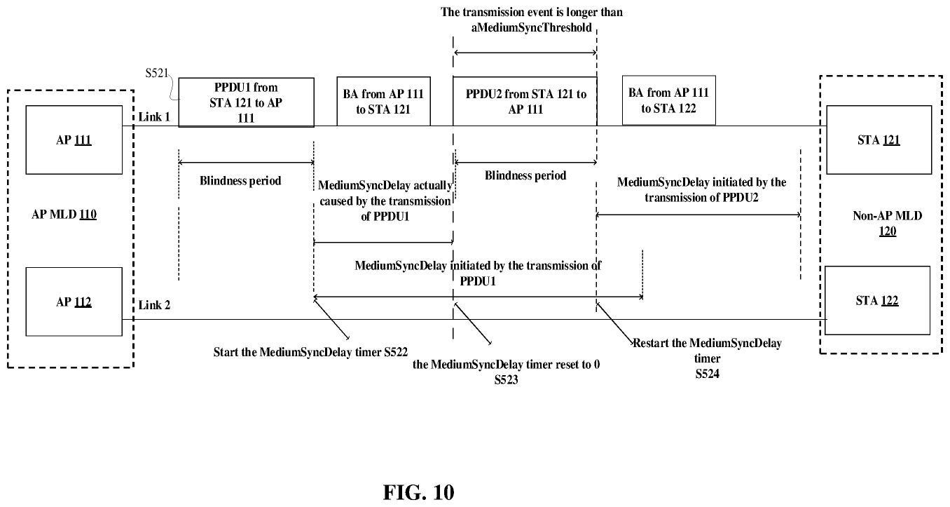

With reference to FIG. 10, the NSTR non-AP MLD 120 which has two affiliated STAs (i.e., the STA 121 and the STA 122), is associated with the AP MLD 110 which has two affiliated APs (i.e., the AP 111 and the AP 112). The link 1 between the AP 111 and the non-AP STA 121 and the link 2 between the AP 112 and the non-AP the STA 122 have been set up between the non-AP MLD 120 and AP MLD 110. The non-AP MLD 120 has one NSTR pair of links including the link 1 and the link 2. The STA 121 transmits a PPDU, such as a PPDU1, to the AP 111, which causes the STA 122 to lose the medium synchronization for a blindness period (step S521). At the end of the transmission of the PPDU1, the STA 122 starts the MediumSyncDelay timer (step S522). During the period of the MediumSyncDelay timer when the MediumSyncDelay is not equal to 0, the STA 122 resets the MediumSyncDelay timer to 0 when the transmission of the PPDU2 starts (step S523) and restarts the MediumSyncDelay timer at the end of the transmission of the PPDU2 if the transmission event of the PPDU2 is also longer than the aMediumSyncThreshold (step S524). The MediumSyncDelay timer initiated by the transmission of the PPDU1 keeps a value exactly the same as a value of the MediumSyncDelay timer initiated when the first STA starts the MediumSyncDelay timer at the end of the transmission of the PPDU1. The MediumSyncDelay has a value actually caused by the transmission of the PPDU1, which represents a time period from the time that the first STA starts the MediumSyncDelay timer to the time that the MediumSyncDelay timer countdowns to zero or is reset to zero. The embodiment provides a solution to the issue for the sequential blindness periods.

### Embodiment 7

After the first STA, such as the STA 122, affiliated with the non-AP MLD 120 that belongs to the NSTR link pair started a MediumSyncDelay timer due to having lost medium synchronization, if the first STA lost medium synchronization again due to the second transmission event performed by the second STA, such as the STA 121, in the link pair affiliated with the same MLD during the MediumSyncDelay timer is running, the first STA resets the MediumSyncDelay timer to 0 when the second transmission event starts and doesn't restart the MediumSyncDelay timer at the end of the second transmission if the second transmission event is not longer than aMediumSyncThreshold.

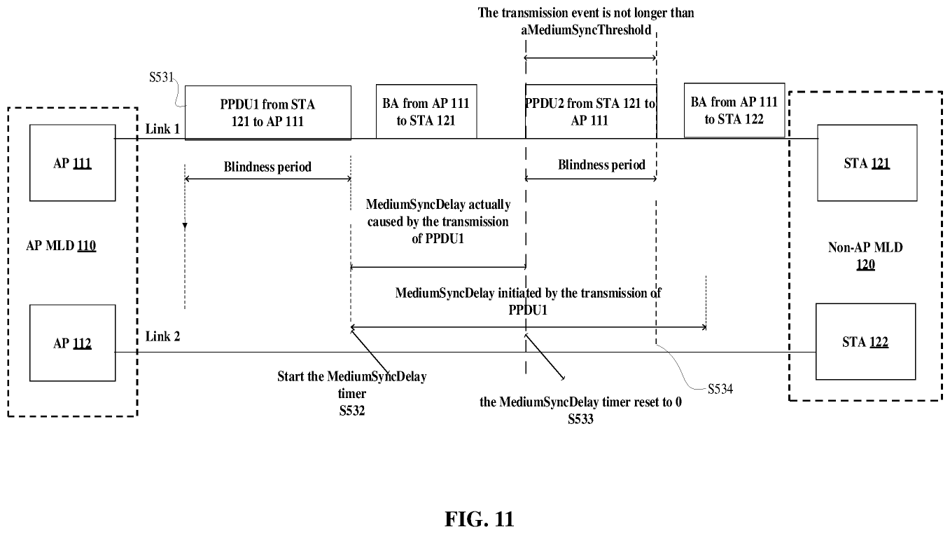

With reference to FIG. 11, the NSTR non-AP MLD 120 which has two affiliated STAs (i.e., the STA 121 and the STA 122), is associated with the AP MLD 110 which has two affiliated APs (i.e., the AP 111 and the AP 112). The link 1 between the AP 111 and the non-AP STA 121 and the link 2 between the AP 112 and the non-AP STA 122 have been set up between the non-AP MLD 120 and AP MLD 110. The non-AP MLD 120 has one NSTR pair of links including the link 1 and the link 2. The STA 121 transmits a PPDU, such as a PPDU1, to the AP 111, which causes the STA 122 to lose the medium synchronization for a blindness period (step S531). At the end of the transmission of the PPDU1, the STA 122 starts the MediumSyncDelay timer (step S532). During the period of the MediumSyncDelay timer when the MediumSyncDelay is not equal to 0, the STA 122 resets the MediumSyncDelay timer to 0 when the transmission of the PPDU2 starts (step S533) and doesn't restart the MediumSyncDelay timer at the end of the transmission of the PPDU2 if the transmission event of the PPDU2 is not longer than aMediumSyncThreshold (step S534). The MediumSyncDelay timer initiated by the transmission of the PPDU1 keeps a value exactly the same as a value of the MediumSyncDelay timer initiated when the first STA starts the MediumSyncDelay timer at the end of the transmission of the PPDU1. The MediumSyncDelay has a value actually caused by the transmission of the PPDU1, which represents a time period from the time that the first STA starts the MediumSyncDelay timer to the time that the MediumSyncDelay timer countdowns to zero or is reset to zero. The embodiment provides a solution to handle the issue for the sequential blindness periods.

### Embodiment 8

After the first STA, such as the STA 122, affiliated with the non-AP MLD 120 that belongs to the NSTR link pair started a MediumSyncDelay timer due to having lost medium synchronization, if the first STA lost medium synchronization again due to the second transmission event performed by the second STA, such as the STA 121, in the link pair affiliated with the same MLD during the MediumSyncDelay timer is running, the first STA when detecting the second transmission event is not longer than aMediumSyncThreshold and keep the MediumSyncDelay timer running and doesn't reset the MediumSyncDelay timer to 0 when the second transmission event starts, and doesn't restart the MediumSyncDelay timer at the end of the second transmission.

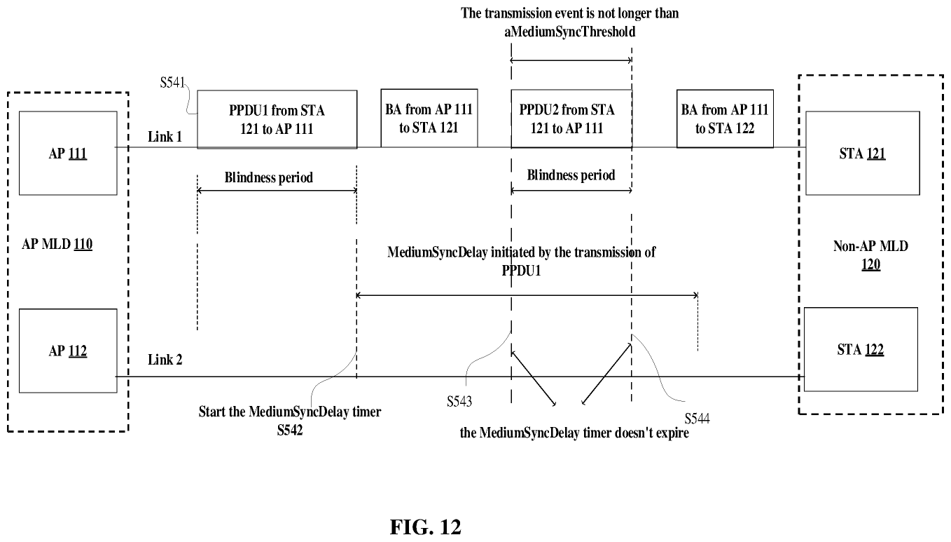

With reference to FIG. 12, the NSTR non-AP MLD 120 which has two affiliated STAs (i.e., the STA 121 and the STA 122), is associated with the AP MLD 110 which has two affiliated APs (i.e., the AP 111 and the AP 112). The link 1 between the AP 111 and the non-AP STA 121 and the link 2 between the AP 112 and the non-AP the STA 122 have been set up between the non-AP MLD 120 and AP MLD 110. The non-AP MLD 120 has one NSTR pair of links including the link 1 and the link 2. The STA 121 transmits a PPDU, such as a PPDU1, to the AP 111, which causes the STA 122 to lose the medium synchronization for a blindness period (step S541). At the end of the transmission of the PPDU1, the STA 122 starts the MediumSyncDelay timer (step S542). During the period of the MediumSyncDelay timer when the MediumSyncDelay is not equal to 0, the first STA doesn't reset the MSD timer to 0 when the transmission of the PPDU2 starts (step S543) and doesn't restart the MediumSyncDelay timer at the end of the transmission of the PPDU2 if the transmission event of the PPDU2 is not longer than aMediumSyncThreshold (step S544). The MediumSyncDelay timer initiated by the transmission of the PPDU1 keeps a value exactly the same as a value of the MediumSyncDelay timer initiated when the first STA starts the MediumSyncDelay timer at the end of the transmission of the PPDU1. The embodiment provides a solution to the issue for the sequential blindness periods.

### Embodiment 9

The transmissions of QoS data frames and management frames adopt different channel access methods, i.e., the EDCA mechanism is used to obtain a TXOP to transmit QoS data frames and DCF is used to access channel to transmit management frames. For the NSTR MLD 120, the first STA, i.e., the STA 122, affiliated with the MLD that belongs to the NSTR link pair has lost medium synchronization due to the transmission event performed by the second STA, such as the STA 121, in the link pair affiliated with the same MLD. The STA 122 starts a MediumSyncDelay timer at the end of the transmission event if the transmission event is longer than aMediumSyncThreshold. During the period of the MediumSyncDelay timer when the MediumSyncDelay is not equal to 0, the STA 122 uses an adjusted ED threshold as a common rule. Specifically, the STA 122 affiliated with non-AP MLD 120 and that has a nonzero MediumSyncDelay timer uses a CCA_ED threshold that is equal to the medium synchronization orthogonal frequency division multiplexing (OFDM) ED threshold which is indicated by the parameter of dot11MSDOFDMEDthreshold. Especially for the transmission of one or more management frames, the first STA uses the CCA_ED threshold that is equal to dot11MSDOFDMEDthreshold.

### Embodiment 10

A non-AP STA, such as the STA 122, affiliated with a non-AP MLD 120 that belongs to the NSTR link pair obtains a TXOP and operates as a TXOP holder. The STA 122 transmits the AAR Control subfield in a frame that is the last frame transmitted by the first STA in the TXOP to an associated first AP, such the AP 112, affiliated with an AP MLD, such as the AP MLD 110, which indicates a link identifier of a second AP, such as the AP 111, affiliated with the same AP MLD, such as the AP MLD 110, to solicit the second AP to transmit a trigger frame to the second non-AP STA, such as the STA 121, affiliated with the same non-AP MLD 120 that belongs to the same NSTR link pair. The STA 122 transmits the last PPDU with the frame carrying the AAR control subfield in the TXOP to the first AP affiliated with the AP MLD 110. The transmission of the last PPDU with the last frame carrying the AAR control in the TXOP indicates that the second AP affiliated with the same AP MLD 110 is solicited to transmit the trigger frame after the end of the last PPDU transmitted by the first STA in the TXOP.

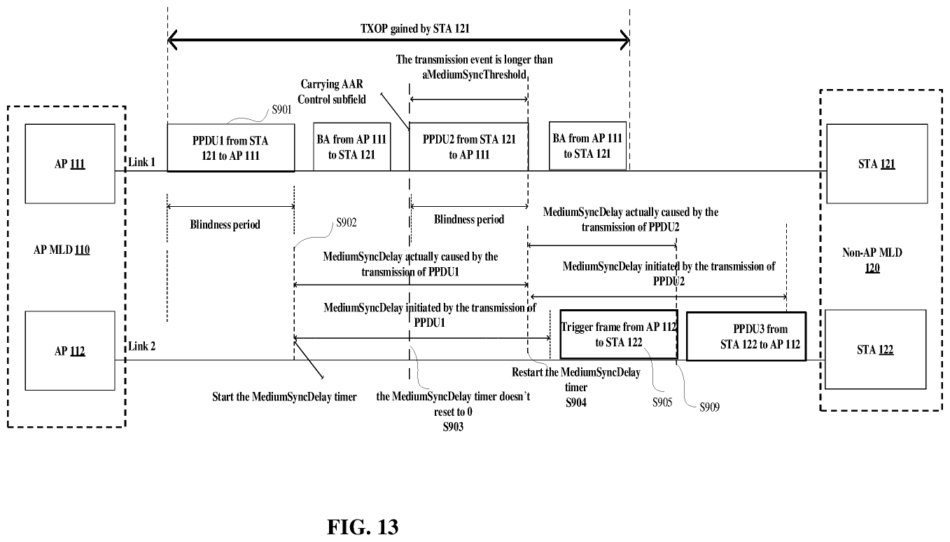

With reference to FIG. 13, the NSTR non-AP MLD 120 which has two affiliated STAs (i.e., the STA 121 and the STA 122), is associated with the AP MLD 110 which has two affiliated APs (i.e., the AP 111 and the AP 112). The link 1 between the AP 111 and the non-AP STA 121 and the link 2 between the AP 112 and the non-AP STA 122 have been set up between the non-AP MLD 120 and AP MLD 110. The non-AP MLD 120 has one NSTR pair of links including the link 1 and the link 2. The STA 121 transmits a PPDU, such as a PPDU1, to the AP 111, which causes the STA 122 to lose the medium synchronization for a blindness period (step S901). At the end of the transmission of the PPDU1, the STA 122 starts the MediumSyncDelay timer (step S902). During the period of the MediumSyncDelay timer when the MediumSyncDelay is not equal to 0, the STA 122 doesn't reset the MSD timer to 0 when the transmission of the PPDU2 starts (step S903) and restarts the MediumSyncDelay timer at the end of the transmission of the PPDU2 if the transmission event of the PPDU2 is longer than aMediumSyncThreshold (step S904). The PPDU2 with the frame carrying the AAR control subfield is the last PPDU transmitted by the STA 121 in the TXOP gained by the STA 121. After the end of the transmission of the PPDU2, the AP 112 transmits the trigger frame to the STA 122 to solicit a UL PPDU from the STA 122 (step S905). When receiving the trigger frame, the STA 122 resets the MediumSyncDelay timer to zero (step S909). The embodiment provides a solution using the transmission of the frame carrying the AAR Control subfield during the TXOP.

Embodiments 1, 2, 3, and 10 may be incorporated into embodiment 9. In other word, an STA, such as the first STA, may perform the method aforementioned in the any combination of the Embodiments 1, 2, 3, 9, and 10. Similarly, Embodiments 4, 5, 6, 7, and 8 may be implemented into a wireless station. In other word, an STA, such as the first STA, may perform the method aforementioned in the any combination of the Embodiments 4, 5, 6, 7, and 8.

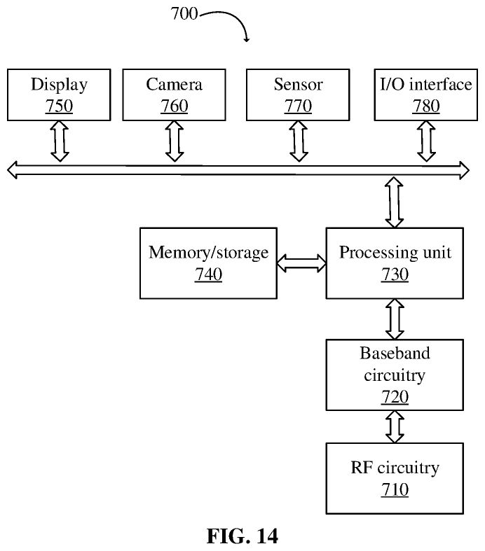

FIG. 14 is a block diagram of an example system 700 for wireless communication according to an embodiment of the present disclosure. Embodiments described herein may be implemented into the system using any suitably configured hardware and/or software. FIG. 14 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the MLD, STA or AP may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in IEEE 802.11be specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated into one processing unit, physically independent, or integrated into one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

Embodiments of the disclosure provides a medium access recovery method executed by a wireless mobile station (STA). When losing medium synchronization due to transmission by another mobile station affiliated with the same multi-link device (MLD), the mobile station starts a medium synchronization delay timer, such as MediumSyncDelay timer, at the end of the transmission by another mobile station. The method improves medium access recovery by at least determining whether to allow backoff in a delay time kept by the delay timer, whether to allow overlapping basic service set (OBSS) packet detection (PD) spatial reuse (SR), or whether to reset the delay timer with respect to a subsequent transmission event, or adjusting an energy detection (ED) threshold.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A medium access recovery method comprising:
starting a medium synchronization delay timer of a wireless station to time a medium synchronization delay period when the wireless station affiliated with a non-access point multi-link device (non-AP MLD) that belongs to a wireless link pair has lost medium synchronization, wherein the medium synchronization delay timer times the medium synchronization delay period; and
using an adjusted energy detection (ED) threshold for clear channel assessment (CCA) during the medium synchronization delay period.

2. The medium access recovery method of claim 1, wherein the adjusted ED threshold is equal to a medium synchronization orthogonal frequency division multiplexing (OFDM) ED threshold indicated by a parameter of dot11MSDOFDMEDthreshold.

3. The medium access recovery method of claim 2, further comprising:
using the adjusted ED threshold for transmission of one or more management frames.

4. The medium access recovery method of claim 1, further comprising:
resetting the medium synchronization delay timer to zero when the wireless station receives a PPDU with a valid medium access control (MAC) protocol data unit (MPDU) which has a duration/ID field carrying duration information; and
not resetting medium synchronization delay timer to zero when the wireless station receives a PPDU with a valid MPDU which has a Duration/ID field carrying no duration information.

5. The medium access recovery method of claim 1, further comprising:
disallowing backoff during the medium synchronization delay period when the wireless station detects a contention-based wireless transmission having a high probability of being at or above a specified signal strength threshold at a specified bandwidth within a period.

6. The medium access recovery method of claim 5, wherein the contention-based wireless transmission comprises IEEE 802.11 transmission of a non-high-throughput (non-HT), high throughput mixed format (HT_MF), high throughput greenfield (HT_GF), very high throughput (VHT), high efficiency (HE), or extremely high throughput (EHT) physical layer protocol data unit (PPDU).

7. The medium access recovery method of claim 5, further comprising:
deferring a beginning of an extended interframe space (EIFS) and allowing backoff during the medium synchronization delay period when the wireless station does not detect the implicit link detection result.

8. The medium access recovery method of claim 1, further comprising:
disallowing OBSS PD SR during the medium synchronization delay period.

9. The medium access recovery method of claim 8, wherein the adjusted ED threshold is not lower than a spatial reuse (SR) overlapping basic service set (OBSS) packet detection (PD) level.

10. The medium access recovery method of claim 1, wherein the wireless link pair comprises a non-simultaneous transmit and receive (NSTR) link pair.

11. A wireless station comprising:
a transceiver; and
a processor connected to the transceiver and configured to execute:
starting a medium synchronization delay timer of a wireless station to time a medium synchronization delay period when the wireless station affiliated with a non-access point multi-link device (non-AP MLD) that belongs to a wireless link pair has lost medium synchronization, wherein the medium synchronization delay timer times the medium synchronization delay period; and
using an adjusted energy detection (ED) threshold for clear channel assessment (CCA) during the medium synchronization delay period.

12. The wireless station of claim 11, wherein the adjusted ED threshold is equal to a medium synchronization orthogonal frequency division multiplexing (OFDM) ED threshold indicated by a parameter of dot11MSDOFDMEDthreshold.

13. The wireless station of claim 12, wherein the processor is further configured to execute:
using the adjusted ED threshold for transmission of one or more management frames.

14. The wireless station of claim 11, wherein the processor is further configured to execute:
resetting the medium synchronization delay timer to zero when the wireless station receives a PPDU with a valid medium access control (MAC) protocol data unit (MPDU) which has a duration/ID field carrying duration information; and
not resetting medium synchronization delay timer to zero when the wireless station receives a PPDU with a valid MPDU which has a Duration/ID field carrying no duration information.

15. The wireless station of claim 11, wherein the processor is further configured to execute:
disallowing backoff during the medium synchronization delay period when the wireless station detects a contention-based wireless transmission having a high probability of being at or above a specified signal strength threshold at a specified bandwidth within a period.

16. The wireless station of claim 15, wherein the contention-based wireless transmission comprises IEEE 802.11 transmission of a non-high-throughput (non-HT), high throughput mixed format (HT_MF), high throughput greenfield (HT_GF), very high throughput (VHT), high efficiency (HE), or extremely high throughput (EHT) physical layer protocol data unit (PPDU).

17. The wireless station of claim 15, wherein the processor is further configured to execute:
deferring a beginning of an extended interframe space (EIFS) and allowing backoff during the medium synchronization delay period when the wireless station does not detect the implicit link detection result.

18. The wireless station of claim 11, wherein the processor is further configured to execute:
disallowing OBSS PD SR during the medium synchronization delay period;
wherein the adjusted ED threshold is not lower than a spatial reuse (SR) overlapping basic service set (OBSS) packet detection (PD) level.

19. The wireless station of claim 11, wherein the wireless link pair comprises a non-simultaneous transmit and receive (NSTR) link pair.

20. A non-transitory machine-readable storage medium having stored thereon instructions that, when executed by a computer, cause the computer to perform a medium access recovery method, comprising:
starting a medium synchronization delay timer of a wireless station to time a medium synchronization delay period when the wireless station affiliated with a non-access point multi-link device (non-AP MLD) that belongs to a wireless link pair has lost medium synchronization, wherein the medium synchronization delay timer times the medium synchronization delay period; and
using an adjusted energy detection (ED) threshold for clear channel assessment (CCA) during the medium synchronization delay period.
